(19) United States
(12) Patent Application Publication
(10) Pub. No.: US 2015/0029206 A1
(43) Pub. Date: Jan. 29, 2015

(54) METHOD AND ELECTRONIC DEVICE FOR DISPLAYING WALLPAPER, AND COMPUTER READABLE RECORDING MEDIUM

(71) Applicant: Samsung Electronics Co., Ltd., Gyeonggi-do (KR)

(72) Inventor: Maria BIALOTA, Warsaw (PL)

(73) Assignee: Samsung Electronics Co., Ltd., Gyeonggi-do (KR)

(21) Appl. No.: 14/294,911

(22) Filed: Jun. 3, 2014

(30) Foreign Application Priority Data
Jul. 23, 2013 (KR) 10-2013-0086693

(51) Int. Cl. G06T 11/00

(52) U.S. Cl. CPC G06T 11/001
USPC 345/589

(57) ABSTRACT

A method and an electronic device for displaying a wallpaper, and a computer readable recording medium having recorded thereon a program to perform the method are provided. The electronic device includes a storage unit that stores a user image and variable data; a display unit that displays the wallpaper; and a controller that selects the user image and the variable data, creates a composite image by reflecting the variable data in the user image, and controls the display of the composite image as the wallpaper through the display unit.

### PRIORITY

This application claims priority under 35 U.S.C. §119(a) to a Korean Patent Application filed in the Korean Intellectual Property Office on Jul. 23, 2013 and assigned Serial No. 10-2013-0086693, the entire content of which is incorporated herein by reference.

### BACKGROUND OF THE INVENTION

1. Field of the Invention

The present invention relates generally to an electronic device for displaying a wallpaper, and more particularly, to an electronic device and a method for displaying a changing wallpaper, and a computer readable recording medium.

2. Description of the Related Art

In recent years, a mobile communication device such as a smart phone has been widely used, and various types of wallpapers have been used. Users want to use a wallpaper in which a user selected image is used.

User selected data may be reflected in generating a wallpaper. For example, a user selects any one of predetermined image sets, and the image selected by the user is reflected in a wallpaper. The predetermined image sets are configured in animation effects. However, the wallpaper generated through the method described above reflects an effect corresponding to the image sets in a predetermined order. Thus, the wallpaper does not dynamically respond to a change in the data, when the user selected data are changed.

### SUMMARY OF THE INVENTION

Aspects of the present invention are to address at least the above-mentioned problems and/or disadvantages and to provide at least the advantages described below. Accordingly, an aspect of the present invention is to provide a method and an electronic device for displaying a wallpaper, and a computer readable recording medium having recorded thereon a program to perform the method, wherein variable data that a user selects can be dynamically reflected on a basis of an image that a user selects.

Another aspect of the present disclosure is to provide a method and an electronic device for displaying a wallpaper, and a computer readable recording medium, wherein a wallpaper personalized depending on a user can be generated and displayed.

Another aspect of the present disclosure is to provide a method and an electronic device for displaying a wallpaper, and a computer readable recording medium, wherein an automatically updated wallpaper can be generated and displayed.

In accordance with an aspect of the present invention, a method for displaying a wallpaper is provided. The method includes selecting at least one user image; selecting variable data; creating a composite image by reflecting the variable data in the user image; and displaying the composite image as a wallpaper of an electronic device.

In accordance with another aspect of the present invention, a computer readable recording medium having recorded thereon a program to perform the steps of: selecting at least one user image, selecting variable data, creating a composite image by reflecting the variable data in the user image, and displaying the composite image as a wallpaper of an electronic device is recorded, is provided.

In accordance with another aspect of the present invention, an electronic device for displaying a wallpaper is provided. The electronic device includes a storage unit that stores a user image and variable data; a display unit that displays the wallpaper; and a controller that selects the user image and the variable data, creates a composite image by reflecting the variable data in the user image, and controls the display of the composite image as the wallpaper through the display unit.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1 is a block diagram illustrating an electronic device for displaying a wallpaper according to an embodiment of the present invention;

FIG. 2 is a block diagram illustrating an electronic device for displaying a wallpaper according to an embodiment of the present invention;

FIG. 3 is a block diagram illustrating a specific configuration of a controller of an electronic device for displaying a wallpaper according to an embodiment of the present invention;

FIG. 4 is a flowchart illustrating a control method of an electronic device for displaying a wallpaper according to an embodiment of the present invention;

FIG. 5 is a flowchart illustrating a specific control method of an electronic device for displaying a wallpaper according to an embodiment of the present invention;

FIG. 6 is a flowchart illustrating a user image processing method of an electronic device for displaying a wallpaper according to an embodiment of the present invention;

FIG. 7 is a flowchart illustrating a method of selecting weather data as variable data according to an embodiment of the present invention;

FIG. 8 is a flowchart illustrating a method of selecting season data as variable data according to an embodiment of the present invention;

FIG. 9 is a flowchart illustrating a method of selecting time data as variable data according to an embodiment of the present invention;

FIG. 10 is a flowchart illustrating a method of selecting place data as variable data according to an embodiment of the present invention;

FIGS. 11A-11C illustrate wallpapers in which weather data selected as variable data is reflected according to embodiments of the present invention;

FIGS. 12A-12C illustrate wallpapers in which season data selected as variable data is reflected according to embodiments of the present invention;

FIGS. 13A-13C illustrate wallpapers in which time data selected as variable data is reflected according to embodiments of the present invention; and

FIGS. 14A-14C illustrate wallpapers in which place data selected as variable data is reflected according to embodiments of the present invention.

### DETAILED DESCRIPTION OF EMBODIMENTS OF THE PRESENT INVENTION

Various embodiments of the present invention will be described in detail with reference to the accompanying drawings. It should be understood that although various embodiments of the present invention are different from each other, they need not be mutually exclusive. For example, in regard to an embodiment, specific forms, structures, and characteristics described herein may be realized through another embodiment without departing from the spirit and scope of the present invention. Moreover, it should be understood that locations or arrangements of separate elements within the disclosed embodiments of the present invention can be changed without departing from the spirit and scope of the present invention. Accordingly, detailed descriptions which will be given below are not intended to be restrictive, and the scope of the present invention should be limited only by the accompanying claims and equivalents thereof.

While terms including ordinal numbers, such as “first” and “second,” etc., may be used to describe various components, such components are not limited by the above terms. The terms are used merely for the purpose to distinguish an element from the other elements. For example, a first element could be termed a second element, and similarly, a second element could be also termed a first element without departing from the scope of the present invention. As used herein, the term “and/or” includes any and all combinations of one or more of the associated listed items.

The terms used in this application are for the purpose of describing particular embodiments only and are not intended to be limiting of the invention. As used herein, the singular forms are intended to include the plural forms as well, unless the context clearly indicates otherwise. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

Unless defined otherwise, all terms used herein have the same meaning as commonly understood by those of skill in the art. Such terms as those defined in a generally used dictionary are to be interpreted to have the meanings equal to the contextual meanings in the relevant field of art, and are not to be interpreted to have ideal or excessively formal meanings unless clearly defined in the present specification. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

According to an embodiment of the present invention, an electronic device may select a user image that is used when a composite image is created. The electronic device may perform image processing on the user image which has been selected for creating a composite image. The electronic device may select an object area, which will be used when a composite image is created, through the image processing.

According to an embodiment of the present invention, the electronic device may select variable data that is reflected when a composite image is created. The variable data are dynamically changed data. For example, the variable data may include at least one of user setup data which a user provides, external data acquired through a web service, self-data of the electronic device, and random data generated as an arbitrary value.

According to an embodiment of the present invention, the electronic device may create a composite image based on variable data and an object area acquired from a user image through image processing. The electronic device may add a dynamic image of the variable data to the object area when creating the composite image. The electronic device may display the created composite image as a wallpaper through a display unit included therein. The electronic device may dynamically modify the composite image by dynamically reflecting a change in the variable data. The electronic device may display the modified composite image as a wallpaper through the display unit.

According to an embodiment of the present invention, the electronic device may be an arbitrary electronic device including a display. The electronic device may include a portable device, such as a smart phone or a cell phone, which has a wireless communication function. The portable device may be referred to as a mobile terminal, a communication terminal, a portable communication terminal, a portable mobile terminal, or the like. For example, the electronic device may be a game machine, a television (TV), a display device, a vehicle head-up display unit, a laptop computer, a tablet computer, a Personal Media Player (PMP), a Personal Digital Assistants (PDA), a navigation device, or the like. The electronic device may be a flexible display device.

According to an embodiment of the present invention, a computer readable recording medium, in which a program is recorded, may include all types of recording mediums in which a program and data are stored to be read by a computer system. For example, the recording medium includes a Read Only Memory (ROM), a Random Access Memory (RAM), a Compact Disk (CD), a Digital Video Disk (DVD)-ROM, a magnetic tape, a floppy disk, an optical data storage device, and an embedded Multi-Media Card (eMMC), and also includes something that is realized in the form of a carrier wave (for example, transmission through the Internet). Moreover, the recording medium may be distributed to computer systems connected with each other through a network so that a computer readable code may be stored and executed in a distributed manner.

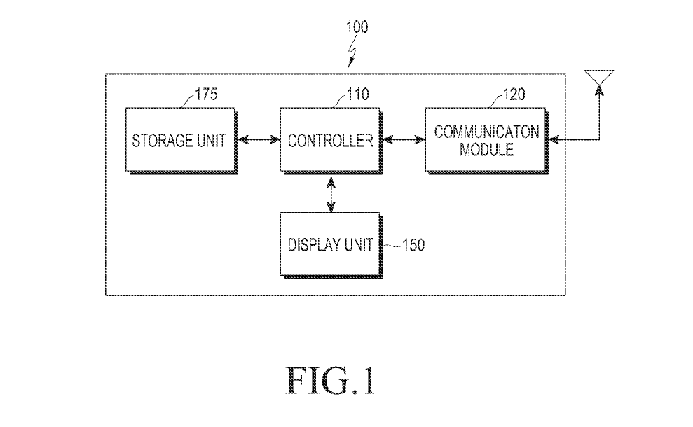

FIG. 1 is a block diagram illustrating an electronic device for displaying a wallpaper according to an embodiment of the present invention. Referring to FIG. 1, the electronic device 100 may include a controller 110, a communication module 120, a storage unit 175, and a display unit 150.

The controller 110 may control the communication module 120, the storage unit 175, and the display unit 150. Moreover, the controller 110 may create a composite image that reflects a user image and variable data, set the created composite image as a wallpaper, and display the wallpaper through the display unit.

The communication module 120 may transmit/receive data to/from an external electronic device through communication under the control of the controller 110.

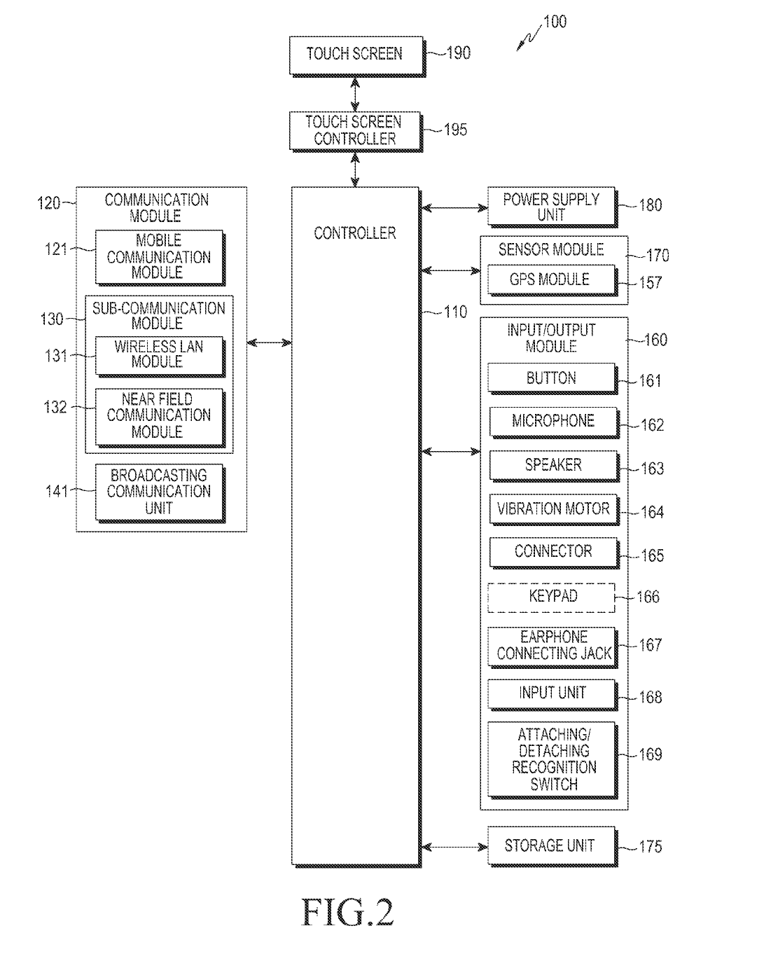

The storage unit 175 may store the user image and the variable data. The display unit 150 may display the wallpaper under the control of the controller 110. Moreover, the display unit 150 may include a touch screen 190 which will be described below with reference to FIG. 2, but is not limited thereto.

Hereinafter, a method and an electronic device for displaying a wallpaper according to embodiments of the present invention will be described with reference to FIGS. 2 to 14.

FIG. 2 is a block diagram illustrating an electronic device for displaying a wallpaper according to an embodiment of the present invention. Referring to FIG. 2, the electronic device 100 may include a controller 110, a communication module 120, an input/output module 160, a sensor module 170, a storage unit 175, a power supply unit 180, a touch screen 190, and a touch screen controller 195.

The controller 110 controls the communication module 120, the input/output module 160, the sensor module 170, the storage unit 175, the power supply unit 180, the touch screen 190, and the touch screen controller 195.

The controller 110 may select a user image and variable data according to an embodiment of the present invention. The controller 110 may create a wallpaper by reflecting the variable data, which are based on the selected user image, and the selected user image. The controller may dynamically reflect a change in the selected variable data and the selected user image in the created wallpaper. The controller 110 may display the wallpaper through the touch screen 190 which is a display unit. A specific configuration of the controller 110 according to an embodiment of the present invention will be more specifically described below with reference to FIG. 3.

The controller 110 may sense a user input event such as a touch event caused by an input unit 168 contacting the touch screen 190, and a hovering event caused by the input unit 168 close to the touch screen 190.

The controller 110 may detect a variety of user inputs received through a camera module (not illustrated), the input/output module 160, the sensor module 170, and the touch screen 190. In addition, the user input may include various types of information, such as a gesture, a voice, an eye movement, iris recognition, and a bio-signal of a user, which is input to the electronic device 100. The controller 110 may control a predetermined step or function corresponding to the detected user input to be executed in the electronic device 100.

The controller 110 may output a control signal to the input unit 168 or a vibration motor 164. The control signal may include information on a vibration pattern, and the input unit 168 and the vibration motor 164 generates a vibration in response to the vibration pattern. The information on the vibration pattern may represent the vibration pattern itself and an identifier of the vibration pattern. Alternatively, the control signal may also simply include only a request for generation of a vibration.

The communication module 120 may include a mobile communication module 121, a sub-communication module 130, and a broadcasting communication unit 141. The sub-communication module 130 may include at least one of a wireless Local Area Network (LAN) module 131 and a near field communication unit 132.

The communication module 120 may receive the user image or the variable data under the control of the controller 110. The electronic device 100 may be connected with a web service, a server, another electronic device (not illustrated), or the like through the communication module 120, and receive the user image or the variable data. The received user image or variable data may be stored in the storage unit 175 under the control of the controller 110.

The mobile communication module 121 may allow the electronic device 100 to be connected with an external electronic device through a mobile communication network, by using one antenna or a plurality of antennas under the control of the controller 110.

The mobile communication module 121 may allow the electronic device 100 to transmit/receive a wireless signal for a voice call, a video call, a Short Message Service (SMS), or a Multimedia Message Service (MMS) to/from another electronic device having a mobile communication function.

The sub-communication module 130 may include at least one of the wireless LAN module 131 and the near field communication module 132. For example, the sub-communication module 130 may include only the wireless LAN module 131, or only the near field communication module 132. Alternatively, the sub-communication unit 130 may include both the wireless LAN module 131 and the near field communication module 132.

The wireless LAN module 131 may be connected to the internet at a place, where a wireless Access Point (AP) is installed, under the control of the controller 110. The wireless LAN module 131 may support a wireless LAN protocol (IEEE 802.11x) of the Institute of Electrical and Electronics Engineers (IEEE).

The near field communication module 132 may perform near field communication in a wireless manner between the electronic device 100 and an external electronic device under the control of the controller 110. The near field communication method may include Bluetooth, Infrared Data Association (IrDA), Near Field Communication (NFC), visible light communication, and the like.

The broadcasting communication unit 141 may receive a broadcasting signal (for example, a TV broadcasting signal, a radio broadcasting signal, or a data broadcasting signal) and additional broadcasting information (for example, Electronic Program Guide (EPG) or Electronic Service Guide (ESG)), which are transmitted from a broadcasting station through a broadcasting communication antenna, under the control of the controller 110.

The input/output module 160 may include at least one of at least one button 161, at least one microphone 162, at least one speaker 163, at least one vibration element 164, the connector 165, the keypad 166, the earphone connecting jack 167, and the input unit 168. The input/output module 160 is not limited thereto, and a cursor control such as a mouse, a track ball, a joystick, or cursor direction keys may be provided in order to control a cursor movement on the touch screen 190.

The buttons 161 may be formed on a front surface, a side surface, or a rear surface of a housing (or a case) of the electronic device 100, and may include at least one of a power/lock button, a volume button, a menu button, a home button, a back button, and a search button.

The microphone 162 may receive a voice or a sound, and generate an electric signal under the control of the controller 110.

The speaker 163 may output sounds corresponding to various signals or data (for example, wireless data, broadcasting data, digital audio data, or digital video data) to the outside of the electronic device 100 under the control of the controller 110. The speaker 163 may output sounds corresponding to functions that the electronic device 100 performs (for example, a button operation tone corresponding to a telephone call, a call connection tone, or a voice of a counterpart user). One or a plurality of speakers 163 may be formed at a proper location or proper locations of the housing of the electronic device 100.

The vibration motor 164 may convert an electric signal into a mechanical vibration under the control of the controller 110. For example, the vibration motor 164 operates when the electronic device 100 in a vibration mode receives a voice call or a video call from another device. One or a plurality of vibration motors 164 may be formed in the housing of the electronic device 100. The vibration motor 164 may operate in response to the user input through the touch screen 190.

The connector 165 may be used as an interface for connecting the electronic device 100 with an external electronic device or a power source. The controller 110 may transmit data stored in the storage unit 175 of the electronic device 100 to the external electronic device or may receive data from the external electronic device through a wired cable connected to the connector 165. Moreover, the electronic device 100 may receive an electric power from the power source through a wired cable connected to the connector 165 or may charge a battery by using the power source. The controller 110 may receive a user image or variable data from an external electronic device through a wired cable connected to the connector 165. The received user image or variable data may be stored in the storage unit 175 under the control of the controller 110.

The keypad 166 may receive a key input from a user to control the electronic device 100. The keypad 166 may include a physical keypad formed in the electronic device 100 or a virtual keypad displayed on the touch screen 190. The physical keypad formed in the electronic device 100 may be excluded based on a performance or a structure of the electronic device 100.

Earphones may be inserted into the earphone connecting jack 167 and thus connected to the electronic device 100.

The input unit 168 may be inserted into and kept in the electronic device 100, and may be extracted or separated from the electronic device 100 when being used. An attaching/detaching recognition switch 169 may be installed in an area in the electronic device 100 into which the input unit 168 is inserted, may operate in response to attaching and detaching of the input unit 168, and may output a signal corresponding to the attaching and the detaching of the input unit 168 to the controller 110. The attaching/detaching recognition switch 169 may directly or indirectly contact the input unit 168 when the input unit 168 is mounted. Accordingly, the attaching/detaching recognition switch 169 may generate a signal corresponding to the attaching or the detaching of the input unit 168 (for example, a signal that notifies of the attaching or the detaching of the input unit 168) based on whether or not there is contact with the input unit 168, and output the signal to the controller 110.

According to the embodiment of the present invention, the electronic device 100 may be connected with an external electronic device by using at least one of the communication module 120, the connector 165, and the earphone connecting jack 167. The external electronic device may include one of various devices, such as earphones, an external speaker, a Universal Serial Bus (USB) memory, a charger, a Cradle/Dock, a Digital Multimedia Broadcasting (DMB) antenna, a mobile payment related device, a health care device (a blood sugar measuring device), a game machine, and a vehicle navigation device, which may be detachably connected to the electronic device 100 in a wired manner. Moreover, the external electronic device may include a Bluetooth communication device which may be wirelessly connected, a Near Field Communication (NFC) device, a Wi-Fi Direct communication device, and a wireless Access Point (AP). The electronic device 100 may be connected to another portable user device or another electronic device, for example, a cell phone, a smart phone, a tablet Personal Computer (PC), a desktop Personal Computer (PC), and a server, in a wired or wireless manner.

According to the embodiment of the present invention, the user input which the electronic device 100 receives may include a user input through the touch screen 190, a gesture input through the camera module, a switch/button input through the button 161 or the keypad 166, a voice input through the microphone 162, and the like.

The sensor module 170 may include at least one sensor that detects a state of the electronic device 100. For example, the sensor module 170 may include at least one of a proximity sensor that detects a user's proximity to the electronic device 100, an illumination sensor that detects a brightness around the electronic device 100, a motion sensor that detects a motion of the electronic device 100 (for example, rotation of the electronic device 100, and acceleration or a vibration of the electronic device 100), a geo-magnetic sensor which detects a point of a compass of the electronic device 100 by using Earth's magnetic field, a gravity sensor which detects an action direction of gravity, an altimeter that detects an altitude by measuring atmospheric pressure, a Global Positioning System (GPS) module 157, and the like. The GPS module 157 may receive electric waves from a plurality of GPS satellites in Earth orbit, and may calculate a location of the electronic device 100 by using arrival time of the electric waves from the GPS satellites to the electronic device 100.

The storage unit 175 may store a signal or data as input and output according to the operation of the communication module 120, the multimedia module 140, the camera module, the input/output module 160, the sensor module 170, or the touch screen 190, under the control of the controller 110. The storage unit 175 may store control programs for control of the electronic device 100 or the controller 110, and other applications.

The term “storage unit” refers to an arbitrary data storage device such as the storage unit 175, the ROM 112 and the RAM 113 in the controller 110, or a memory card (for example, a Secure Digital (SD) memory card and a memory stick) that is mounted to the electronic device 100. The storage unit 175 may also include a non-volatile memory, a volatile memory, a Hard Disk Drive (HDD), or a Solid State Drive (SSD).

The storage unit 175 may store applications with various functions such as a navigation, a video call, a game, a time based alarm application, images for providing a Graphic User Interface (GUI) related to the applications, user information, a document, databases or data related to a method of processing a touch input, wallpapers (a menu screen and a standby screen) or operating programs necessary for driving the electronic device 100, and images photographed by the camera module (not illustrated).

Further, the storage unit 175 may store a user image and variable data. The storage unit 175 may store at least one of brightness data, color data, and dynamic image data, which are mapped to the variable data, in the form of a table. For example, the storage unit 175 may store brightness data, color data, and dynamic image data corresponding to the variable data under the control of the controller 110.

The storage unit 175 is a machine (for example, a computer) readable medium, and the term referred to as “a machine readable medium” may be defined as a medium that provides data to the machine so that the machine may perform a specific function. The storage unit 175 may include a non-volatile memory and a volatile memory. All such mediums should be tangible so that commands transferred through the mediums into the machine may be detected by a physical mechanism that reads the commands.

The machine readable medium is not limited thereto, and may include at least one of a floppy disk, a flexible disk, a hard disk, a magnetic tape, a Compact Disc Read-Only Memory (CD-ROM), an optical disk, a punch card, a paper tape, a RAM, a Programmable Read-Only Memory (PROM), an Erasable PROM (EPROM), a FLASH-EPROM, and an embedded Multi Media Card (eMMC).

The power supply unit 180 may supply an electric power to one or a plurality of batteries, which are disposed in the housing of the electronic device 100, under the control of the controller 110. The one or the plurality of batteries supply the electric power to the electronic device 100.

Moreover, the power supply unit 180 may supply an electric power, which is input from an external power source through a wired cable connected with the connector 165, to the electronic device 100. Furthermore, the power supply unit 180 may also supply an electric power, which is wirelessly input from an external power source through a wireless charging technology, to the electronic device 100.

The electronic device 100 may include at least one touch screen 190 that provides user graphic interfaces corresponding to various services (for example, a telephone call, data transmission, broadcasting, and photography) to the user. The touch screen 190 may output an analog signal corresponding to at least one user input, which is input to the user graphic interface, to the touch screen controller 195.

The touch screen 190 may receive at least one user input through a user's body (for example, a finger including a thumb) or the input unit 168 (for example, a stylus pen, an electronic pen, or the like). For example, the user input through the touch screen 190 may be realized by a resistive method, a capacitive method, an infrared method, an acoustic wave method, or a combination of the methods.

The touch screen 190 may include at least one touch panel that can sense a touch or access from the finger and the input unit 168 so that inputs through the finger and the input unit 168 may be received. The at least one touch panel may provide mutually different output values to the touch screen controller 195, and the touch screen controller 195 may distinguish values input from the at least one touch screen panel and identify which of the inputs through the finger and the input unit 168 the input from the touch screen 190 corresponds to.

The touch is not limited to the contact between the touch screen 190 and a user's body or a touchable input unit, and may include non-contact. A detectable interval in the touch screen 190 may be varied based on a performance or a structure of the electronic device 100.

The touch screen controller 195 converts an analog signal input from the touch screen 190 into a digital signal, and transmits the digital signal to the controller 110. The controller 110 may control the touch screen 190 by using the digital signal received from the touch screen controller 195. The touch screen controller 195 may detect a value (for example, a current value) output through the touch screen 190 to identify a hovering interval or distance as well as a location of the user input, and may also convert the identified distance value into a digital signal (for example, Z-coordinate) to provide the digital signal to the controller 110.

Moreover, the touch screen controller 195 may detect a value (for example, a current value) output through the touch screen 190 corresponding to a pressure that the user input unit applies to the touch screen 190, and may also convert the identified pressure value into a digital signal and provide the digital signal to the controller 110.

FIG. 3 is a block diagram illustrating a specific configuration of a controller of an electronic device for displaying a wallpaper according to an embodiment of the present invention. Referring to FIG. 3, the controller 110 may include a user image selecting unit 111, an image processing unit 112, a variable data selecting unit 113, a composite image creating unit 114, and a wallpaper displaying unit 115.

The user image selecting unit 111 may select a user image as a base when a wallpaper is generated. The user image selecting unit 111 may select at least one of images stored in a storage unit 175 as a user image in response to a user input. For example, the user image selecting unit 111 may select at least one of the images stored in the storage unit 175 of the electronic device as a user image in response to a received selection signal of a user. The selection signal of the user is an input signal related to selection of the user image.

The user image selecting unit 111 may select a user image according to a preset value. The value may be preset by a user, a manufacturing company of the electronic device, or a providing company of a mobile communication service in which the electronic device is used. For example, the user image selecting unit 111 may select an image, recently stored based on a current date, among the images stored in the storage unit 175 of the electronic device as a user image. The images stored in the storage unit 175 of the electronic device 100 may include an image taken from a camera installed in the electronic device 100, an image received from an external electronic device, and an image received from a web server through a communication module 120.

According to an embodiment of the present invention, the user image selecting unit 111 may select a user image as a base when a wallpaper is generated. The user image selecting unit 111 may select a plurality of images among the images stored in the storage unit 175 as user images in correspondence to a user input. For example, the user image selecting unit 111 may select a plurality of images among the images stored in the storage unit 175 of the electronic device as user images in response to a received selection signal of a user. The selection signal of the user is an input signal related to a selection of a user image.

The image processing unit 112 may perform image processing on the at least one selected user image which is used for creating a composite image. The image processing may include determining a category to which the user image belongs, separating object areas in the user image, analyzing the object areas in the user image, and selecting an object area that will be used when a composite image is created.

Moreover, the image processing which the image processing unit 112 performs may include converting a size or a format of the user image, analyzing the object areas (objects) in the user image, recognizing which object area each of the object areas corresponds to in the user image, processing a pixel point of the user image, processing on an area among the object areas in the user image, and geometric processing on the user image. For example, digital image recognition techniques (for example, an image recognition technique using an OpenCV Library) may be used for the image processing which the image processing unit 112 performs.

The image processing unit 112 may determine a category, to which at least one user image belongs, through the image processing. The image processing unit 112 may determine the category, to which the user image belongs, according to a preset value. The value may be preset by a user, a manufacturing company of the electronic device, or a providing company of mobile communication service in which the electronic device is used.

The image processing unit 112 may determine which category at least one user image belongs to among preset categories, in response to a category determination signal of a user. The category determination signal of the user is an input signal related to determining the category to which the user image belongs.

The categories may include a category of a portrait image, a category of a wallpaper, and a category of a mixed image in which a portrait image and a background image are mixed. The categories may be preset by a user, a manufacturing company of the electronic device, or a providing company of mobile communication service in which the electronic device is used. Moreover, the categories may be reset by a user, a manufacturing company of the electronic device, or a providing company of mobile communication service in which the electronic device is used.

The categories may have a range value of an occupancy ratio that corresponds to an object area of a human being to a whole area of the user image. The range of the ratio may be preset by a user, a manufacturing company of the electronic device, or a providing company of mobile communication service in which the electronic device is used. The range of the preset ratio for each category may be reset by a user. The ratio may be preset by a user, a manufacturing company of the electronic device, or a providing company of mobile communication service in which the electronic device is used. Moreover, the ratio may be reset by a user.

For example, the image processing unit 112 may detect an image of a human body part (for example, an eye, a nose, a mouth, an ear, an arm, a leg, or the like) in the whole area of the user image. The image processing unit 112 may determine an image area of a human being by detecting an external silhouette of a human body in the whole area of the user image, when the image of the human body part is detected in the user image. The image processing unit 112 may calculate an occupancy ratio of the image area of the human being which has been detected to the whole area of the user image. The image processing unit 112 may determine which of the preset categories the calculated ratio belongs to. As another example, the image processing unit 112 may determine a category to which the user image belongs as a wallpaper category, when the image of the human being has not been detected in the user image.

The image processing unit 112 may separate object areas in the user image through the image processing. The image processing unit 112 may separate at least one object area in the user image through the image processing. Each of the separated object areas may represent an inherent object. The inherent object may belong to one of the preset groups in the electronic device. The image processing unit 112 may analyze the object areas configuring the user image through the image processing. The image processing unit 112 may analyze the object areas in order to determine a group to which the at least one object area in the user image belongs. The image processing unit 112 may analyze which of the preset groups the object area belongs to. The preset groups may be classified by information of an object area that represents one independent object. For example, the groups may include information capable of classifying at least one of the sky, the ground, a mountain, a sea, a tree, a building, a human face, an external silhouette of a human body, and other independent objects. The object areas may be classified, because object information which the object areas belonging to is presented differently in the respective groups. The groups may be set according to a preset value. The value may be preset by a user, a manufacturing company of the electronic device, or a providing company of a mobile communication service in which the electronic device is used.

Moreover, the image processing unit 112 may determine which of the preset groups the classified object areas belong to, in response to a group determination signal of a user. The group determination signal of the user is an input signal related to determination of a group to which an object area belongs.

The image processing unit 112 may perform a process of analyzing the objects in the user image, by determining the category to which the user image belongs. Moreover, the image processing unit 112 may perform image processing of analyzing the objects in the user image, without performing the image processing of determining the category to which the user image belongs.

The image processing unit 112 may select an object area, which will be used when a composite image is created, from the user image through the image processing. The image processing unit 112 may select an object area, which will be used when a wallpaper is generated, chopped from the whole area of the user image according to a preset value, when the image processing of analyzing the objects in the user image is performed on the selected user image. The value may be preset by a user, a manufacturing company of the electronic device, or a providing company of a mobile communication service in which the electronic device is used.

Moreover, the image processing unit 112 may select at least one of the object areas as an area that will be used when a composite image is created, in correspondence to a user input.

The variable data selecting unit 113 may select variable data that is reflected when a composite image is created. The variable data selecting unit 113 may select the variable data according to a preset value. The value may be preset by a user, a manufacturing company of the electronic device, or a providing company of a mobile communication service in which the electronic device is used. Moreover, the electronic device may select variable data, which will be reflected when a wallpaper is generated, in response to a received selection signal of a user. The selection signal of the user is an input signal related to the selection of the variable data. The variable data are dynamically changed data. For example, the variable data may include at least one of user setup data which a user provides, external data acquired through a web service, self-data of the electronic device, and random data generated as an arbitrary value.

According to an embodiment of the present invention, the user setup data which the user provides are stored in the storage unit 175 of the electronic device 100 in response to a user input signal. The user may set an event operation occurrence condition of the electronic device 100. The electronic device 100 may perform a preset function by the user, when the event operation occurrence condition is satisfied. The user setup data may include image data related to performing the preset function by the user. The event operation occurrence condition may be generated based on data set by the user in the electronic device 100. The data set by the user in the electronic device 100 may include a season, weather, date, time, a place, a temperature, an atmospheric pressure, and the like. For example, when a date set in the electronic device 100 is identical with a date included in the user set data, a wallpaper generated according to an embodiment of the present invention may perform an event operation of reflecting a dynamic image related to the corresponding date in the wallpaper.

According to an embodiment of the present invention, the external data acquired through the web service may dynamically reflect a change in at least one of a season, weather, time, and a place. For example, the external data may include at least one of weather data, season data, time data, and place data.

According to an embodiment of the present invention, the weather data may include temperature information, humidity information, wind speed information, rainfall probability information, and atmospheric pressure information.

According to an embodiment of the present invention, the season data may include season information for each location. For example, the season data may be generated based on location information and date information of the corresponding location.

According to an embodiment of the present invention, the time data may include current time information for each location, sunrise time information for each location, and sunset time information for each location.

According to an embodiment of the present invention, the place data may include location information of a place where a device is located, image information of a place, and season information of a place.

According to an embodiment of the present invention, the self-data of the electronic device 100 may include data which the electronic device 100 has acquired from the electronic device itself. For example, the self-data of the electronic device 100 may include information measured through a sensor included in the electronic device 100, location information calculated through a Global Positioning System (GPS) included in the electronic device 100, a current date information, time information and location information of the electronic device 100, and information related to an operation of the electronic device 100. The information measured through the sensor may include temperature information, humidity information, and atmospheric pressure information.

According to an embodiment of the present invention, the random data generated as an arbitrary value may include periodically or aperiodically changing data. The electronic device 100 may store values of brightness, contrast, gamma, and colors, which correspond to the changing data, namely, variable data, in the form of a table in the storage unit 175. Moreover, the electronic device 100 may store image objects corresponding to the variable data described above in the storage unit 175.

The composite image creating unit 114 may create a composite image by reflecting the selected object area and the selected variable data. The composite image creating unit 114 may create the composite image by using the object area which will be used during the creating of the composite image, and by selecting the variable data which will be reflected during the creating of the composite image. The composite image creating unit 114 may create the composite image through at least one image processing technique of converting a size of the object area, adding a dynamic image related to the variable data to the object area, changing a brightness of the object area, and changing colors of the object area, in the selected object area.

Moreover, the composite image creating unit 114 may convert a size of the object area. For example, the electronic device may convert the size of the object area according to a resolution of a display unit of the electronic device. Furthermore, the electronic device may convert a size of the image according to a user input value.

The composite image creating unit 114 may create a composite image by adding an image related to variable data to the object area. A dynamic image related to variable data may include a dynamic image of a variable data related to a season, a dynamic image of variable data related to weather, a dynamic image of variable data related to time, a dynamic image of variable data related to a place, a dynamic image of variable data related to an operation state of the electronic device 100, and a dynamic image of random data generated in the electronic device 100. The dynamic images may have at least one set value corresponding thereto. The set value corresponding to the dynamic images may include at least one of a brightness set value, a contrast set value, a gamma set value, and color set values. The electronic device 100 may store the set values corresponding to the respective dynamic images in the form of a table in the storage unit 175.

The composite image creating unit 114 may reflect a dynamic image of variable data related to a season in the object area. The composite image creating unit 114 may create a single composite image by composing the object area with the dynamic image of the variable data related to the season when creating the image. For example, the dynamic image of the variable data related to the season may include a dynamic image of a tree, a leaf, a grass, a flower, a mountain, a sea, or the like. Moreover, the electronic device may compose the object area with an image of a muffler, gloves, a raincoat, or the like as a dynamic image related to the season. At least one of the images stored in the storage unit 175 may be selected as a dynamic image in response to a user input signal.

The composite image creating unit 114 may reflect a dynamic image of variable data related to weather in the object area. The composite image creating unit 114 may create a single composite image by composing the object area with the dynamic image of the variable data related to the weather when creating the image. For example, the dynamic image of the variable data related to the weather may include a dynamic image of snowfall, a dynamic image of rainfall, an image of snowfall and snow cover (for example, an image that can be changed depending on an amount of snowfall), an image in which a wind blows according to a real wind speed and a real wind direction, or the like. Moreover, the electronic device may compose the object area with an image of an umbrella, sunglasses, a cap, or the like as a dynamic image related to the weather. At least one of the images stored in the storage unit 175 may be selected as a dynamic image in response to a user input signal.

The composite image creating unit 114 may reflect a dynamic image of variable data related to time in the object area. The composite image creating unit 114 may create a single composite image by composing the object area with the dynamic image of the variable data related to the time when creating the image. For example, the dynamic image of the variable data related to the time may include dynamic images of sunrise and sunset that are mapped with time set in the electronic device 100 and location information of the electronic device, a dynamic image of an alarm clock informing of the morning, a dynamic image of the sun informing of the meridian, a dynamic image of an evening glow informing of the evening, a dynamic image of a star and the moon informing of the night, an image of a constellation at dawn, or the like. Moreover, the electronic device may compose the object area with an image of a morning coffee, nightclothes, or the like as a dynamic image related to the time. At least one of the images stored in the storage unit 175 may be selected as a dynamic image in response to a user input signal.

The composite image creating unit 114 may reflect a dynamic image of variable data related to a place in the object area. The composite image creating unit 114 may create a single composite image by composing the object area with the dynamic image of the variable data related to the place when creating the image. For example, the dynamic image of the variable data related to the place may include an image of a building that represents a location of the electronic device 100, an image that a user has stored in the storage unit 175 of the electronic device 100, an image of a famous place in each country, an image of a mountain, an image of a sea, or the like. The dynamic image of the variable data related to the place may be dynamically changed depending on a season, weather, or time. The dynamic image of the variable data related to the place may be dynamically changed based on location information of the electronic device 100. For example, a dynamic image of a company is reflected in a wallpaper when the electronic device 100 is located at the company, and a dynamic image of a house is reflected in a wallpaper when the electronic device 100 is located at the house.

The composite image creating unit 114 may reflect a dynamic image of variable data related to an operation state of the electronic device 100 in the object area. The composite image creating unit 114 may create a single composite image by composing the object area with the dynamic image of the variable data related to the operation state of the electronic device 100 when creating the image. For example, the dynamic image of the variable data related to the operation state of the electronic device 100 may include a dynamic image of an airplane corresponding to a boarding mode, a dynamic image of a letter corresponding to message reception, a dynamic image of a telephone corresponding to a phone reception operation, or the like.

The composite image creating unit 114 may dynamically reflect a dynamic image of random data generated in the electronic device 100 in the object area. The composite image creating unit 114 may create a single composite image by composing the object area with the dynamic image of the random data generated in the electronic device 100 when creating the image. The composite image creating unit 114 may randomly select at least one of the dynamic images of the variable data described above as a dynamic image of the random data generated in the electronic device 100.

The composite image creating unit 114 may dynamically modify a composite image by reflecting a change in the selected variable data. The composite image creating unit 114 may modify the created composite image by reflecting a change in the variable data according to a preset period. The period may be preset by a user, a manufacturing company of the electronic device, or a providing company of mobile communication service in which the electronic device is used.

The composite image creating unit 114 may dynamically modify a composite image by aperiodically reflecting a change in the variable data. For example, the composite image creating unit 114 may dynamically reflect variable data related to a change in an operation state of the electronic device 100 in the composite image, when the operation state of the electronic device 100 is changed.

The wallpaper displaying unit 115 may control the display of a wallpaper through a display unit 150, when the created composite image is set as a wallpaper. Moreover, the wallpaper displaying unit 115 may control the dynamic display of a modified composite image through the display unit 150, when the composite image creating unit 114 modifies the composite image based on a change in the variable data.

Although the elements of the electronic device 100 have been separately illustrated in the drawings in an embodiment of the present invention in order to represent that the elements may be functionally and logically separated, this does not necessarily imply that the elements are physically separated or realized as a separate code.

Furthermore, some of the elements of the electronic device 100 may be omitted.

In the present invention, the respective elements may imply a functional and logical combination of hardware for implementing the spirit and scope of the present disclosure and software for driving the hardware. For example, the elements may imply a predetermined code and a logical unit of a hardware resource for execution of the predetermined code, and it can be readily deduced by those skilled in the art to which the present invention pertains that the elements do not necessarily imply a physically connected code or one type of hardware.

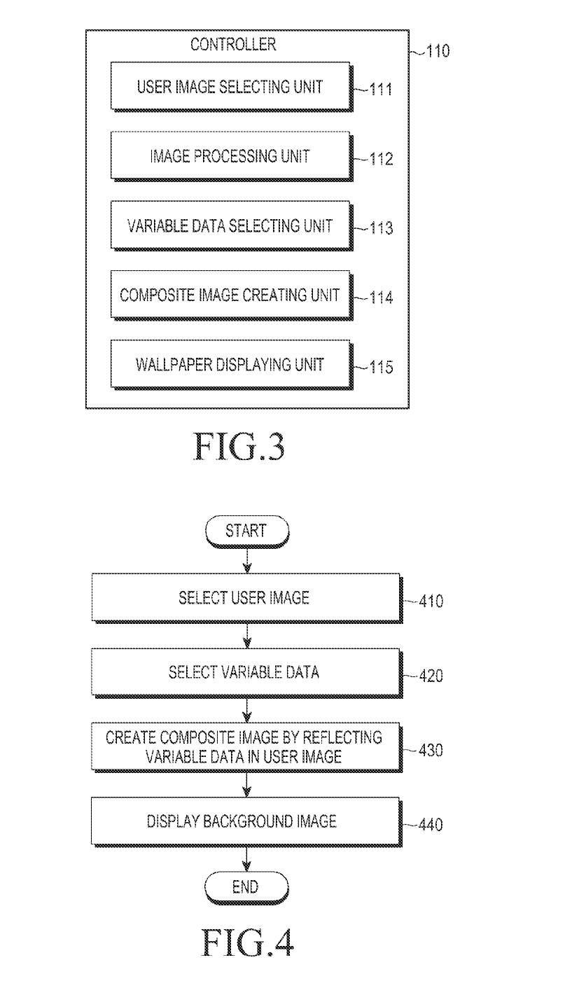

FIG. 4 is a flowchart illustrating a control method of an electronic device for displaying a wallpaper according to an embodiment of the present invention. Referring to FIG. 4, the electronic device may select at least one of images stored in a storage unit 175 as a user image in step 410. The selected user image may be used when a composite image is created. For example, the electronic device may select at least one of the images stored in the storage unit 175 of the electronic device as a user image in response to a received selection signal of a user. The selection signal of the user is an input signal related to selection of the user image. The electronic device may select a user image according to a preset value. The value may be preset by a user, a manufacturing company of the electronic device, or a providing company of a mobile communication service in which the electronic device is used.

In an embodiment of the present invention, the electronic device may select a plurality of images among the images stored in the storage unit 175 as user images. The selected user images may be used when a composite image is created. For example, the electronic device may select a plurality of images among the images stored in the storage unit 175 of the electronic device as user images in response to a received selection signal of a user. The selection signal of the user is an input signal related to a selection of a user image. The electronic device may select user images according to a preset value. The value may be preset by a user, a manufacturing company of the electronic device, or a providing company of a mobile communication service in which the electronic device is used.

The electronic device may perform image processing on the at least one selected user image before a composite image is created. For example, the electronic device may perform at least one image processing of determining a category to which the selected user image belongs, separating object areas in the user image, analyzing the object areas in the user image, and selecting an object area that will be used when a composite image is created.

The electronic device may select variable data that is reflected when a composite image is created, in step 420. The electronic device may select the variable data according to a preset value. The set value may be preset by a user, a manufacturing company of the electronic device, or a providing company of a mobile communication service in which the electronic device is used. Moreover, the electronic device may select variable data, which will be reflected when a wallpaper is generated, in response to a received selection signal of a user. The selection signal of the user is an input signal related to the selection of the variable data. The variable data are dynamically changed data. For example, the variable data may include at least one of user setup data which a user provides, external data acquired through a web service, self-data of the electronic device, and random data generated as an arbitrary value.

The electronic device may create a composite image by reflecting the selected variable data in the selected user image or the selected object area of the user image, in step 430. The electronic device may create the composite image through various image processing techniques. The electronic device may create the composite image through at least one image processing technique of converting a size of the object area, adding a dynamic image related to the variable data to the object area, changing a brightness of the object area, and changing colors of the object area, in at least one object area in the user image.

The electronic device may set the created composite image as a wallpaper and control the display of the wallpaper through a display unit, in step 440. Moreover, the electronic device may control the dynamic display of a modified composite image through the display unit, when the composite image is modified based on a change in the variable data.

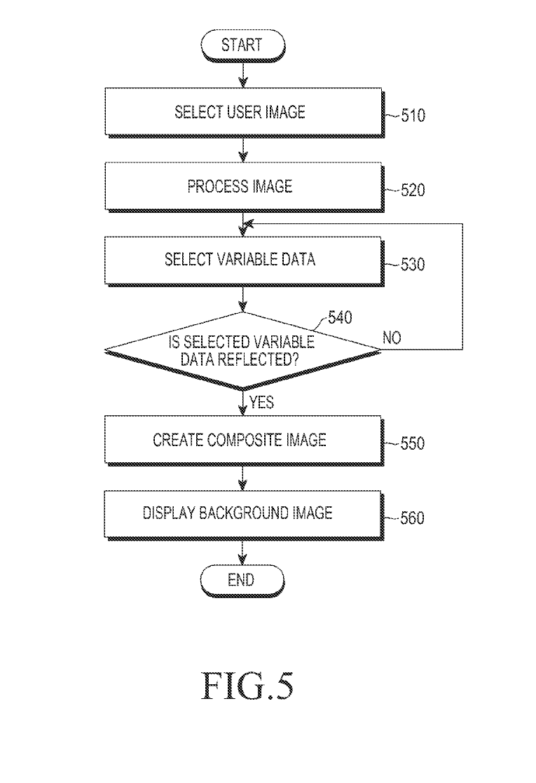

FIG. 5 is a flowchart illustrating a specific control method of an electronic device for displaying a wallpaper according to an embodiment of the present invention. Referring to FIG. 5, the electronic device may select at least one of images stored in a storage unit 175 as a user image in step 510. The selected user image may be used when a composite image is created. For example, the electronic device may select at least one of the images stored in the storage unit 175 of the electronic device as a user image in response to a received selection signal of a user. The selection signal of the user is an input signal related to selection of the user image. The electronic device may select a user image according to a preset value. The value may be preset by a user, a manufacturing company of the electronic device, or a providing company of a mobile communication service in which the electronic device is used.

In an embodiment of the present invention, the electronic device may select a plurality of images among the images stored in the storage unit 175 as user images. The selected user images may be used when a composite image is created. For example, the electronic device may select a plurality of images among the images stored in the storage unit 175 of the electronic device as user images in response to a received selection signal of a user. The selection signal of the user is an input signal related to selection of a user image. The electronic device may select user images according to a preset value. The value may be preset by a user, a manufacturing company of the electronic device, or a providing company of a mobile communication service in which the electronic device is used.

When at least one user image is selected, the electronic device may perform image processing on the selected user image, in step 520. The electronic device may select at least one object area chopped from a whole area of the selected user image through the image processing. The electronic device may use the at least one object area when creating a composite image. For example, the electronic device may perform at least one image processing of determining a category to which the selected user image belongs, separating object areas in the user image, analyzing the object areas in the user image, and selecting an object area that will be used when a composite image is created.

The electronic device may select variable data that is reflected when a composite image is created, in step 530. The electronic device may select the variable data according to a preset value. The set value may be preset by a user, a manufacturing company of the electronic device, or a providing company of a mobile communication service in which the electronic device is used. Moreover, the electronic device may select variable data, which will be reflected when a wallpaper is generated, in response to a received selection signal of a user. The selection signal of the user is an input signal related to the selection of the variable data. The variable data are dynamically changed data. For example, the variable data may include at least one of user setup data which a user provides, external data acquired through a web service, self-data of the electronic device, and random data generated as an arbitrary value.

The electronic device may determine whether or not the selected variable data is reflected when creating a composite image, in step 540. The electronic device may determine whether or not the selected variable data is reflected when creating a composite image, according to a preset value. The value may be preset by a user, a manufacturing company of the electronic device, or a providing company of a mobile communication service in which the electronic device is used. Moreover, the electronic device may determine whether or not the selected variable data is reflected when creating a composite image, in response to a received determination signal of a user. When the selected variable data are reflected, the electronic device may perform a next process. Otherwise, when the selected variable data are not reflected, the electronic device may proceed to step 530 and reselect a variable data.

The electronic device may create a composite image by reflecting the selected variable data in at least one object area among the areas in the user image, in step 550. The electronic device may create the composite image by performing various image processing based on the at least one object area and the selected variable data. For example, the electronic device may create the composite image by performing at least one image processing of converting a size of the object area, composing the object area with a dynamic image related to the variable data, changing a brightness of the object area, and changing colors of the object area, in the at least one object area.

The electronic device may set the created composite image as a wallpaper, and control the display of the wallpaper through a display unit, in step 560. Moreover, the electronic device may control the dynamic display of a modified composite image through the display unit, when the composite image is modified based on a change in the variable data.

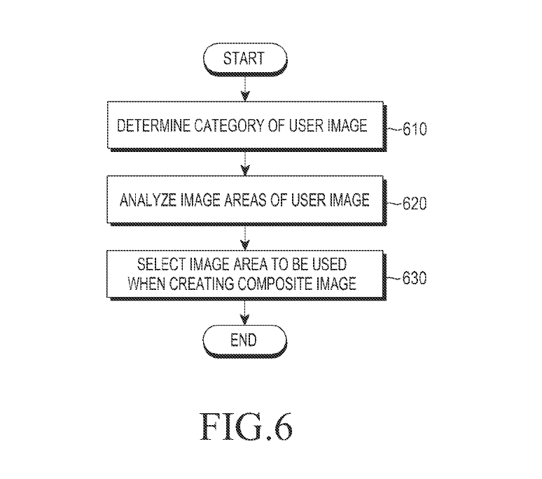

FIG. 6 is a flowchart illustrating a user image processing method of an electronic device for displaying a wallpaper according to an embodiment of the present invention. Referring to FIG. 6, in step 610, the electronic device may determine which of preset categories a user image belongs to, when the user image is selected. For example, the electronic device may determine a category to which the user image belongs, in response to a received category determination signal of a user. Moreover, the electronic device may determine the category to which the user image belongs, depending on an occupancy ratio that corresponds to a specific object area to a whole area of the user image. The category may include a category of a portrait image, a category of a wallpaper, and a category of a mixed image in which a portrait image and a background image are mixed. The category may be preset by a user, a manufacturing company of the electronic device, or a providing company of mobile communication service in which the electronic device is used. The category may be reset by a user, a manufacturing company of the electronic device, or a providing company of mobile communication service in which the electronic device is used.

The electronic device may analyze object areas of the user image, in step 620. The electronic device may analyze the object areas for configuring the user image through image processing. The electronic device may determine which of preset groups the completely analyzed object areas belong to. The preset groups may be classified by information of an object area representing one independent object.

The electronic device may select at least one object area, which will be used when a composite image is created, among the areas configuring the user image according to a preset value, in step 630. The value may be preset by a user, a manufacturing company of the electronic device, or a providing company of mobile communication service in which the electronic device is used. The electronic device may select at least one object area, which will be used when a composite image is created, among the areas configuring the user image in response to a received selection signal of a user.

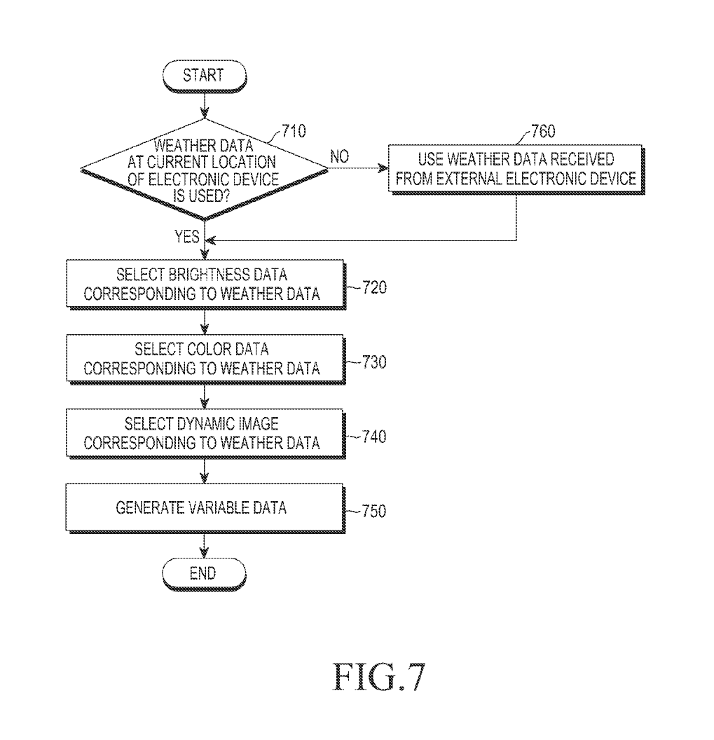

FIG. 7 is a flowchart illustrating a method of selecting weather data as a variable data according to an embodiment of the present invention. Referring to FIG. 7, an electronic device may select whether or not weather data at a current location of the electronic device are used as variable data, according to a preset value in step 710. The electronic device may proceed to step 720 when the weather data at the current location of the electronic device is selected as variable data.

Otherwise, when the weather data at the current location of the electronic device are not selected as variable data, the electronic device may select weather data received from an external electronic device as variable data in step 760. The electronic device may receive the weather data from the external electronic device in response to a selection signal of a user and select the received weather data as variable data. For example, when a user selects weather data of a location intended by the user, the electronic device may receive the selected weather data from an external electronic device and select the received weather data as variable data. The electronic device may perform step 720 when the variable data is selected.

The electronic device may select brightness data corresponding to the weather data from a storage unit in step 720, when the weather data are selected. The electronic device may also receive the brightness data corresponding to the weather data from an external electronic device and select the brightness data.

The electronic device may select color data corresponding to the weather data from the storage unit in step 730, when the weather data are selected. The electronic device may also receive the color data corresponding to the weather data from an external electronic device, and select the color data.

The electronic device may select a dynamic image corresponding to the weather data from the storage unit in step 740, when the weather data are selected. The dynamic image corresponding to the weather data may reflect at least one of temperature information, humidity information, wind speed information, rainfall probability information, and atmospheric pressure information. A dynamic image of variable data related to the weather may include a dynamic image of snowfall, a dynamic image of rainfall, an image of snowfall and snow cover (for example, an image that can be changed depending on an amount of snowfall), an image in which a wind blows according to a real wind speed and a real wind direction, or the like. The dynamic image of the variable data related to the weather may include an image of an umbrella, sunglasses, a cap, or the like. At least one of the images stored in the storage unit 175 may be selected as a dynamic image in response to a user input signal. The electronic device may also receive the dynamic image corresponding to the weather data from an external electronic device, and select the dynamic image.

The electronic device may generate variable data related to weather, including at least one of the brightness data, the color data, and the dynamic image, in step 750. For example, when the weather data are dynamically changed, the electronic device may dynamically generate the weather related variable data including at least one of the brightness data, the color data, and the dynamic image, which correspond to the changed weather data.

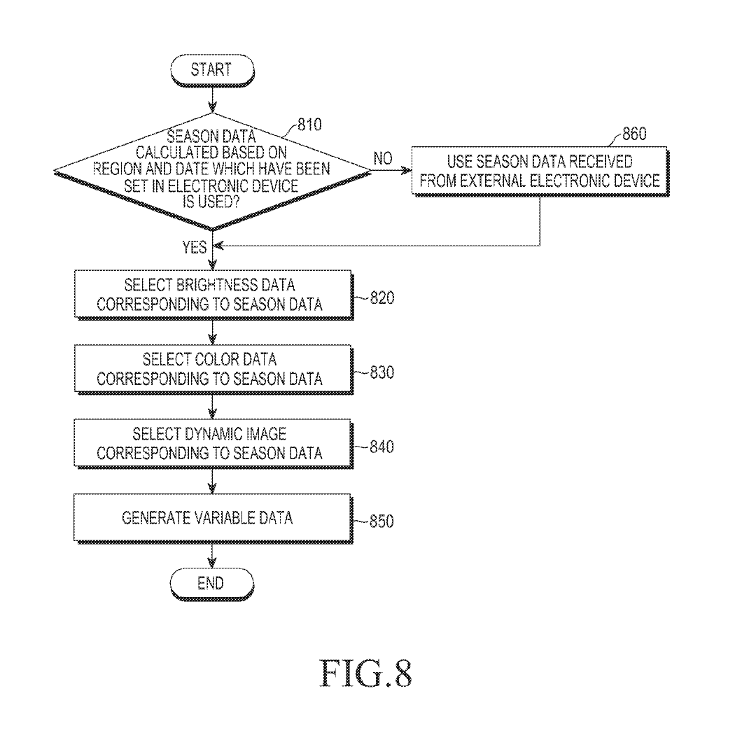

FIG. 8 is a flowchart illustrating a method of selecting season data as a variable data according to an embodiment of the present invention. Referring to FIG. 8, an electronic device may select whether or not season data, calculated based on region data and date data that have been set in the electronic device, are used as variable data, according to a preset value in step 810. The electronic device may proceed to step 820 when the season data calculated in the electronic device are selected as variable data.

Otherwise, when the season data calculated in the electronic device are not selected as variable data, the electronic device may select season data received from an external electronic device as variable data in step 860. The electronic device may receive the season data from the external electronic device in response to a selection signal of a user and select the received season data as variable data. For example, when a user selects season data of a region (for example, a city) intended by the user, the electronic device may receive the selected season data from an external electronic device and select the received season data as variable data. The electronic device may perform step 820 when the variable data are selected.

The electronic device may select brightness data corresponding to the season data from a storage unit in step 820, when the season data are selected. The electronic device may also receive the brightness data corresponding to the season data from an external electronic device and select the brightness data.

The electronic device may select color data corresponding to the season data from the storage unit in step 830, when the season data are selected. The electronic device may also receive the color data corresponding to the season data from an external electronic device and select the color data.

The electronic device may select a dynamic image corresponding to the season data from the storage unit in step 840, when the season data are selected. For example, the dynamic image corresponding to the season data may include a dynamic image of a tree, a leaf, a grass, a flower, a mountain, a sea, or the like. The dynamic image corresponding to the season data may include an image of a muffler, gloves, a raincoat, or the like. At least one of the images stored in the storage unit 175 may be selected as a dynamic image in response to a user input signal. The electronic device may also receive the dynamic image corresponding to the season data from an external electronic device and select the dynamic image.

The electronic device may generate variable data related to a season, including at least one of the brightness data, the color data, and the dynamic image, in step 850. For example, when the season data are dynamically changed, the electronic device may dynamically generate the season related variable data including at least one of the brightness data, the color data, and the dynamic image, which correspond to the changed season data.

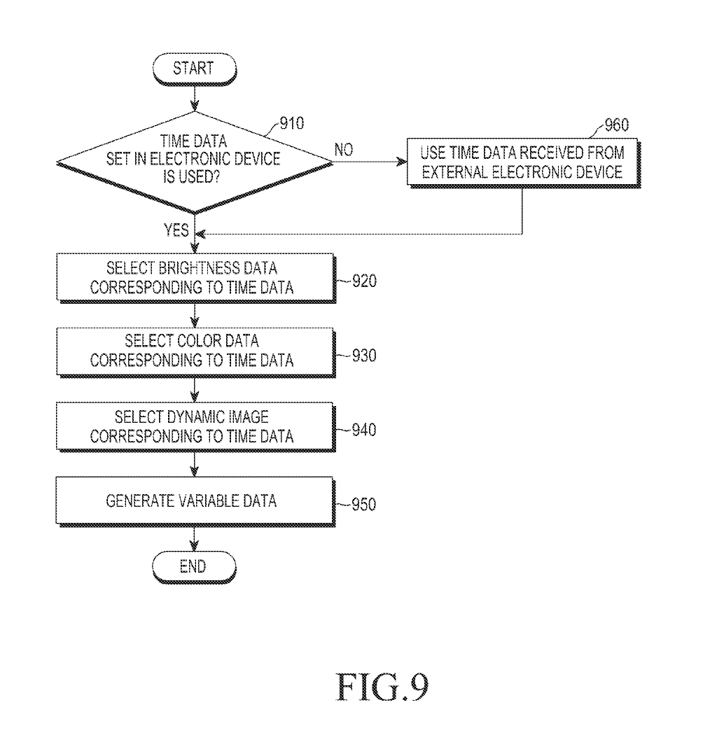

FIG. 9 is a flowchart illustrating a method of selecting time data as a variable data according to an embodiment of the present invention. Referring to FIG. 9, an electronic device may select whether or not time data, which has been set in the electronic device, are used as variable data, according to a preset value in step 910. The electronic device may proceed to step 920 when the time data set in the electronic device are selected as variable data.

Otherwise, when the time data set in the electronic device are not selected as variable data, the electronic device may select time data received from an external electronic device as variable data in step 960. The electronic device may receive the time data from the external electronic device in response to a selection signal of a user, and select the received time data as variable data. For example, when a user selects time data of a region (for example, a city) intended by the user, the electronic device may receive the selected time data from an external electronic device and select the received time data as variable data. The electronic device may perform step 920 when the variable data are selected.

The electronic device may select brightness data corresponding to the time data from a storage unit in step 920, when the time data are selected. The electronic device may also receive the brightness data corresponding to the time data from an external electronic device and select the brightness data.

The electronic device may select color data corresponding to the time data from the storage unit in step 930, when the time data are selected. The electronic device may also receive the color data corresponding to the time data from an external electronic device and select the color data.

The electronic device may select a dynamic image corresponding to the time data from the storage unit in step 940, when the time data are selected. For example, the dynamic image corresponding to the time data may include dynamic images of sunrise and sunset that are mapped with time set in the electronic device 100 and location information of the electronic device, a dynamic image of an alarm clock informing of the morning, a dynamic image of the sun informing of the meridian, a dynamic image of an evening glow informing of the evening, a dynamic image of a star and the moon informing of the night, an image of a constellation at dawn, or the like. The dynamic image related to the time may include an image of a morning coffee, nightclothes, or the like. At least one of the images stored in the storage unit 175 may be selected as a dynamic image in response to a user input signal. The electronic device may also receive the dynamic image corresponding to the time data from an external electronic device and select the dynamic image.

The electronic device may generate variable data related to time, including at least one of the brightness data, the color data, and the dynamic image, in step 950. For example, when the time data is dynamically changed, the electronic device may dynamically generate the time related variable data including at least one of the brightness data, the color data, and the dynamic image, which correspond to the changed time data.

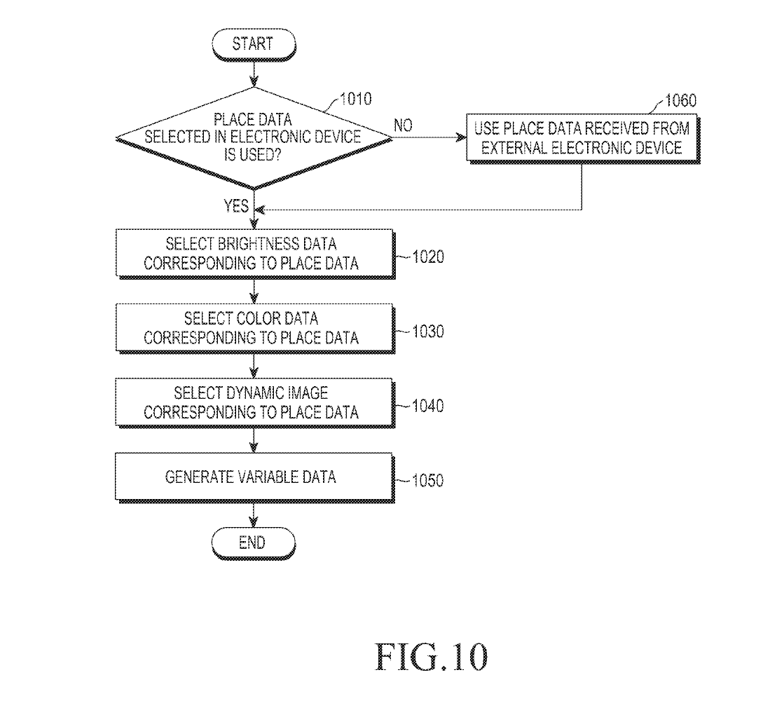

FIG. 10 is a flowchart illustrating a method of selecting place data as a variable data according to an embodiment of the present invention. Referring to FIG. 10, an electronic device may select whether or not one of place data stored in the electronic device is used as variable data, according to a preset value in step 1010. The electronic device may proceed to step 1020 when one of the place data stored in the electronic device is selected as variable data.

Otherwise, when the place data stored in the electronic device are not selected as variable data, the electronic device may select place data received from an external electronic device as variable data in step 1060. The electronic device may receive the place data from the external electronic device in response to a selection signal of a user, and select the received place data as variable data. For example, when a user selects data of a place (for example, a famous place in each country) intended by the user, the electronic device may receive the selected place data from an external electronic device and select the received place data as variable data. The electronic device may perform step 1020 when the variable data are selected.

The electronic device may select brightness data corresponding to the place data from a storage unit in step 1020, when the place data are selected. The electronic device may also receive the brightness data corresponding to the place data from an external electronic device and select the brightness data.

The electronic device may select color data corresponding to the place data from the storage unit in step 1030, when the place data are selected. The electronic device may also receive the color data corresponding to the place data from an external electronic device and select the color data.

The electronic device may select a dynamic image corresponding to the place data from the storage unit in step 1040, when the place data are selected. For example, the dynamic image corresponding to the place data may include an image of a building that represents a location of the electronic device 100, an image which a user has stored in the storage unit 175 of the electronic device 100, an image of a famous place in each country, an image of a mountain, an image of a sea, or the like. The dynamic image corresponding to the place data may be dynamically changed according to a season, weather, time, or the like. The dynamic image corresponding to the place data may be dynamically changed when a location of the electronic device is changed. For example, a dynamic image of a company is reflected in a wallpaper when the electronic device 100 is located at the company, and a dynamic image of a house is reflected in a wallpaper when the electronic device 100 is located at the house. At least one of the images stored in the storage unit 175 may be selected as a dynamic image in response to a user input signal. The electronic device may also receive the dynamic image corresponding to the place data from an external electronic device and select the dynamic image.

The electronic device may generate variable data related to a place, including at least one of the brightness data, the color data, and the dynamic image, in step 1050. For example, when the place data is dynamically changed, the electronic device may dynamically generate the place related variable data including at least one of the brightness data, the color data, and the dynamic image, which correspond to the changed place data.

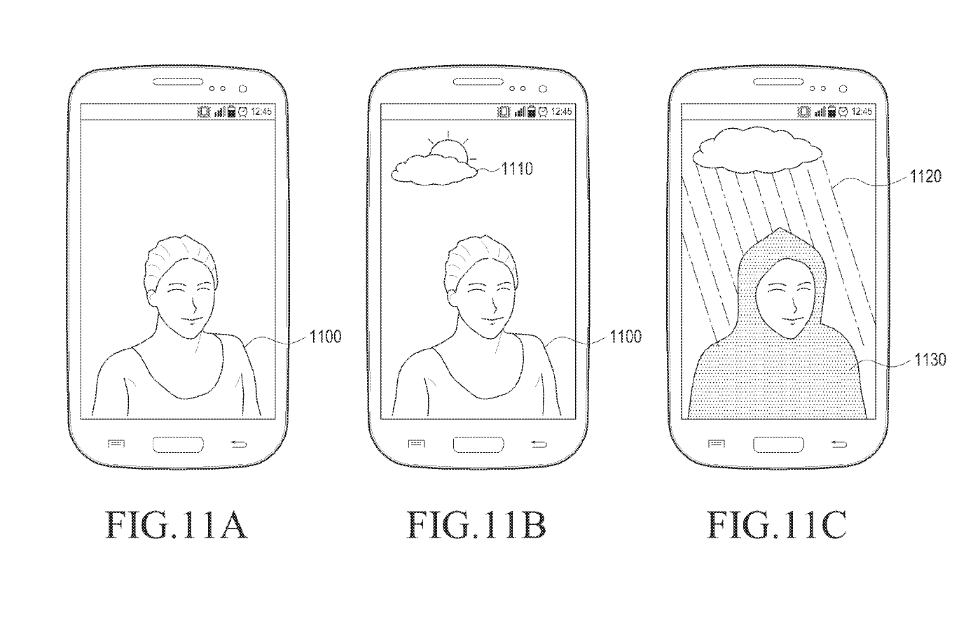

FIGS. 11A-11C illustrate wallpapers in which weather data are reflected as variable data according to embodiments of the present invention. Referring to FIG. 11A, an object area 1100 that will be used when a wallpaper is generated in an electronic device is illustrated. The electronic device may select the object area 1100 as a base when a wallpaper is generated. The electronic device may select at least one object area 1100 of areas in a user image by performing image processing on the user image.

Referring to FIG. 11B, the electronic device may reflect an image 1110 of a cloud and a sun, which is a dynamic image corresponding to variable data related to selected weather, in the object area 1100. The electronic device may create a composite image by reflecting the variable data related to the selected weather based on the selected object area. The electronic device may display the created composite image as a wallpaper through a display unit.

Referring to FIG. 11C, the electronic device may reflect an image 1130 of a raincoat, which is a dynamic image corresponding to variable data related to selected weather, in the object area 1100. The electronic device may create a composite image by reflecting a dynamic image 1120 of rainfall from a cloud, which is a dynamic image corresponding to the variable data related to the selected weather. The electronic device may display the created composite image as a wallpaper through the display unit.

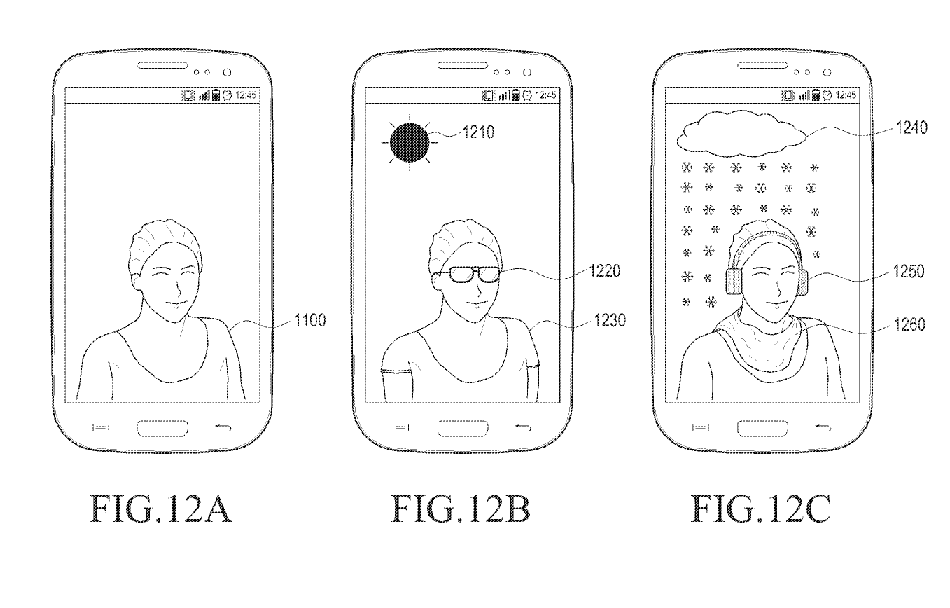

FIGS. 12A-12C illustrate wallpapers in which season data are reflected as variable data according to embodiments of the present invention. Referring to FIG. 12A, an object area 1100 that will be used when a wallpaper is generated in an electronic device is illustrated. The electronic device may select the object area 1100 as a base when a wallpaper is generated. The electronic device may select at least one object area 1100 of areas in a user image by performing image processing on the user image.

Referring to FIG. 12B, the electronic device may reflect an image 1220 of sunglasses and an image 1230 of clothes, which are dynamic images corresponding to variable data related to a selected season, in the object area 1100. The electronic device may create a composite image by reflecting a dynamic image 1210 of the sun, which is a dynamic image corresponding to variable data related to a selected season. The electronic device may change a brightness and/or a color of a wallpaper according to a change in variable data related to a season. The electronic device may display the created composite image as a wallpaper through a display unit.

Referring to FIG. 12C, the electronic device may reflect an image 1250 of earmuffs and an image 1260 of a muffler, which are dynamic images corresponding to variable data related to a selected weather, in the object area 1100. The electronic device may create a composite image by reflecting a dynamic image 1240 of snowfall from a cloud, which is a dynamic image corresponding to the variable data related to a selected weather. The electronic device may change a brightness and/or a color of a wallpaper according to a change in variable data related to a season. The electronic device may display the created composite image as a wallpaper through the display unit.

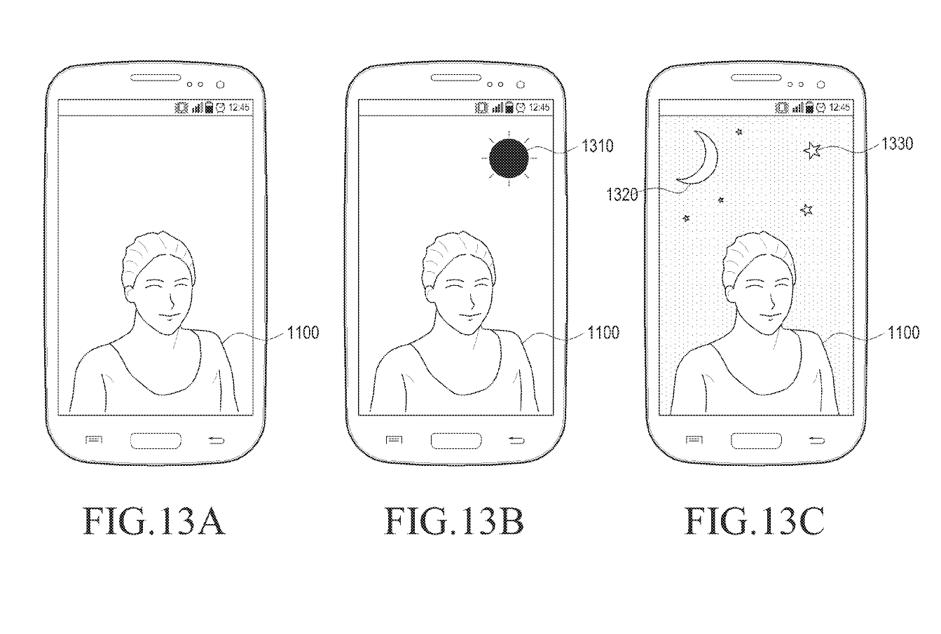

FIGS. 13A-13C illustrate wallpapers in which time data are reflected as variable data according to embodiments of the present invention. Referring to FIG. 13A, an object area 1100 that will be used when a wallpaper is generated in an electronic device is illustrated. The electronic device may select the object area 1100 as a base when a wallpaper is generated. The electronic device may select at least one object area 1100 of areas in a user image by performing image processing on the user image.

Referring to FIG. 13B, the electronic device may create a composite image by reflecting a dynamic image 1310 of the sun, which is a dynamic image corresponding to variable data related to a selected time, in the object area 1100. The electronic device may change a brightness and/or a color of a wallpaper according to a change in variable data related to time. The electronic device may display the created composite image as a wallpaper through a display unit.

Referring to FIG. 13C, the electronic device may create a composite image by reflecting a dynamic image 1320 of the moon and a dynamic image 1330 of a star, which are dynamic images corresponding to variable data related to a selected time, in the object area 1100. The electronic device may change a brightness and/or a color of a wallpaper according to a change in variable data related to time. The electronic device may display the created composite image as a wallpaper through a display unit.

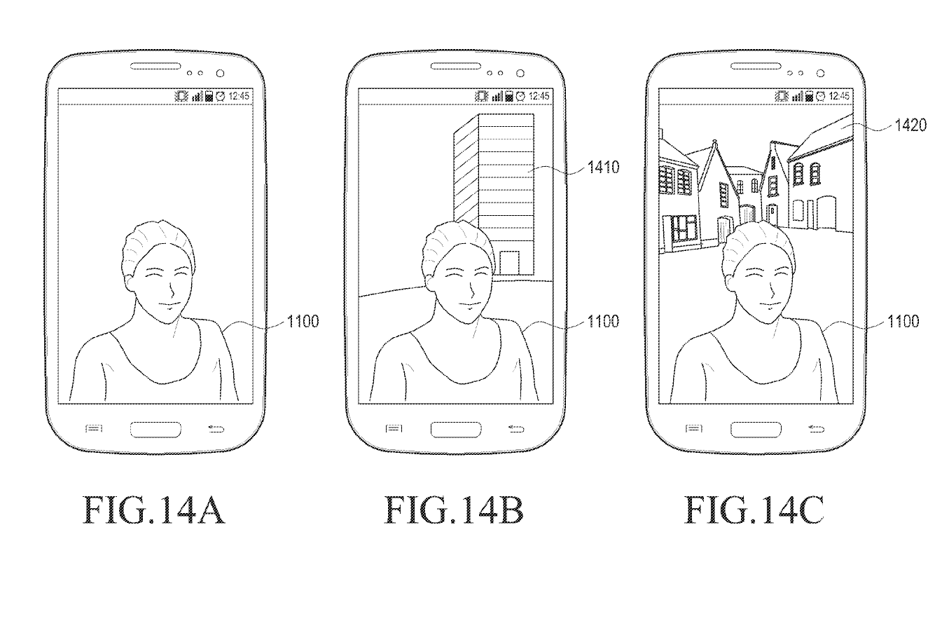

FIGS. 14A-14C illustrate wallpapers in which place data are reflected as variable data according to embodiments of the present invention. Referring to FIG. 14A, an object area 1100 that will be used when a wallpaper is generated in an electronic device is illustrated. The electronic device may select the object area 1100 as a base when a wallpaper is generated. The electronic device may select at least one object area 1100 of areas in a user image by performing image processing on the user image.

Referring to FIG. 14B, the electronic device may create a composite image by reflecting a dynamic image 1410 of a building, which is a dynamic image corresponding to variable data related to a selected place, in the object area 1100. The electronic device may change a brightness and/or a color of a wallpaper according to a change in variable data related to a place. The electronic device may display the created composite image as a wallpaper through a display unit.

Referring to FIG. 14C, the electronic device may create a composite image by reflecting a dynamic image 1420 of a house, which is a dynamic image corresponding to variable data related to a selected place, in the object area 1100. The electronic device may change a brightness and/or a color of a wallpaper according to a change in variable data related to a place. The electronic device may display the created composite image as a wallpaper through a display unit.

According to the embodiments of the present invention, although the electronic device generating and displaying the wallpaper reflecting any one of the weather related variable data, the season related variable data, the time related variable data, and the place related variable data, has been described, the wallpaper which the electronic device displays is not limited thereto, and the wallpaper may reflect at least one of the weather related variable data, the season related variable data, the time related variable data, and the place related variable data.

As described above, although the present invention has described the specific matters such as concrete components, the limited embodiments, and the drawings, they are provided merely to assist in general understanding of the present invention, and the present invention is not limited to the embodiments.

Various modifications and changes can be made from the description by those skilled in the art. Accordingly, the spirit and scope of the present invention should not be limited or determined by the embodiments of the present invention described above, and it should be noted that not only the claims which will be described below but also their equivalents fall within the spirit and scope of the present invention.

What is claimed is:

1. A method of displaying a wallpaper, the method comprising:
selecting at least one user image;
selecting variable data;
creating a composite image by reflecting the variable data in the user image; and
displaying the composite image as a wallpaper of an electronic device.

2. The method of claim 1, wherein the variable data comprises data reflecting a change in at least one of a season, weather, time, a place, and an operation state of the electronic device.

3. The method of claim 1, wherein selecting the variable data comprises generating the variable data based on at least one external data selected from external data received from an external electronic device.

4. The method of claim 1, wherein selecting the variable data comprises generating the variable data based on at least one data selected from user setup data which a user provides, self-data of the electronic device, and random data generated as an arbitrary value in the electronic device.

5. The method of claim 1, wherein creating the composite image comprises creating the composite image by reflecting at least one of a brightness value, a color value, and a dynamic image, which correspond to the variable data, in an object area.

6. The method of claim 1, further comprising:
at least one image processing of determining a category of the user image, analyzing object areas in the user image, and selecting at least one object area, which will be used when the composite image is created, among the analyzed object areas, before creating the composite image.

7. The method of claim 1, further comprising:
dynamically modifying the wallpaper by reflecting a change in the variable data, when the variable data are changed.

8. A computer readable recording medium having recorded thereon a program to perform a method of displaying a wallpaper, the method comprising:
selecting at least one user image;
selecting variable data;
creating a composite image by reflecting the variable data in the user image; and
displaying the composite image as a wallpaper of an electronic device.

9. An electronic device for displaying a wallpaper, the electronic device comprising:
a storage unit that stores a user image and variable data;
a display unit that displays the wallpaper; and
a controller that selects the user image and the variable data, creates a composite image by reflecting the variable data in the user image, and controls the display of the composite image as the wallpaper through the display unit.

10. The electronic device of claim 9, wherein the variable data comprises data reflecting a change in at least one of a season, weather, time, a place, and an operation state of the electronic device.

11. The electronic device of claim 9, further comprising:
a communication module that receives the variable data from an external electronic device.

12. The electronic device of claim 9, wherein the variable data are generated based on at least one external data selected from external data received from an external electronic device.

13. The electronic device of claim 9, wherein the variable data are generated based on at least one data selected from user setup data which a user provides, self-data of the electronic device, and random data generated as an arbitrary value in the electronic device.

14. The electronic device of claim 9, wherein the controller creates the composite image by reflecting at least one of a brightness value, a color value, and a dynamic image, which correspond to the variable data, in an object area.

15. The electronic device of claim 9, wherein the controller performs at least one image processing of determining a category of the user image, analyzing object areas in the user image, and selecting at least one area, which will be used when the composite image is created, among object areas in the user image, before creating the composite image.

16. The electronic device of claim 9, wherein the controller dynamically modifies the wallpaper by reflecting a change in the variable data, when the variable data are changed.
